(19) United States
(12) Patent Application Publication
(10) Pub. No.: US 2015/0062399 A1
(43) Pub. Date: Mar. 5, 2015

(54) IMAGING APPARATUS AND METHOD FOR CONTROLLING IMAGING APPARATUS

(71) Applicant: CANON KABUSHIKI KAISHA, Tokyo (JP)

(72) Inventor: Keiichiro Ishihara, Yokohama-shi (JP)

(21) Appl. No.: 14/457,507

(22) Filed: Aug. 12, 2014

(30) Foreign Application Priority Data
Aug. 28, 2013 (JP) 2013-176930

(51) Int. Cl. H04N 5/378; H04N 5/232; G02B 27/64

(52) U.S. Cl. CPC H04N 5/378; G02B 27/646; H04N 5/23264
USPC 348/302

(57) ABSTRACT

An imaging apparatus, comprises an imaging optical system; a birefringent optical unit configured to separate a ray into an ordinary ray and an extraordinary ray; a light selection unit constituted by an ordinary ray selection element and an extraordinary ray selection element; an image sensor constituted by a first pixel group that receives an extraordinary ray, and a second pixel group that receives an ordinary ray; an image generation unit configured to generate an ordinary ray image based on signals acquired from pixels belonging to the first pixel group, and generate an extraordinary ray image based on signals acquired from pixels belonging to the second pixel group; and an image processing unit configured to calculate a subject distance, using the ordinary ray image and the extraordinary ray image.

### BACKGROUND OF THE INVENTION

1. Field of the Invention

The present invention relates to an imaging apparatus that can simultaneously capture a plurality of images.

2. Description of the Related Art

Various techniques for acquiring distance information to a subject based on images acquired by an imaging apparatus have been proposed, and the depth from defocus (DFD) method is one such technique. According to the DFD method, a plurality of images having different degrees of blur is acquired with changing the capturing parameters, such as the focus position and aperture, and a subject distance is estimated from the changed degrees of blur included in the plurality of images.

As an invention related to the DFD method, Japanese Patent Application Laid-open No. 2010-016743 discloses an apparatus that computes a correlation degrees of blur for each processing target area using a plurality of images having different degrees of blur captured with different capturing parameters as an input, and calculates the subject distance based on the correlation degrees of blur.

### SUMMARY OF THE INVENTION

To measure a subject distance using the DFD method, a plurality of images must be captured with changing the capturing parameters, such as the focus position, focal length and aperture. However in the case of a conventional capturing method disclosed in Japanese Patent Application Laid-open No. 2010-016743, the positions of the focusing lens and aperture are changed in order to changing these capturing parameters, hence a time difference is generated in the capturing. As a result, positional shift is generated among the plurality of captured images due to the subject movement and camera shaking.

In the case of measuring the subject distance using the DFD method, the changes of blur of a same subject must be compared. However if positional shift is generated among the input images, the comparison targets shift, so accurate subject distance cannot be acquired.

To solve these problems, it is necessary to acquire a plurality of images by which different degrees of blur can be acquired and of which positions are not shifted.

With the foregoing in view, it is an object of the present invention to provide an imaging apparatus that can simultaneously capture a plurality of images having different degrees of blur.

The present invention in its one aspect provides an imaging apparatus, comprises an imaging optical system; a birefringent optical unit configured to separate a ray that passed through the imaging optical system into an ordinary ray and an extraordinary ray; a light selection unit constituted by an ordinary ray selection element configured to implement transmitting an ordinary ray entering from the birefringent optical unit and an extraordinary ray selection element configured to implement transmitting an extraordinary ray entering from the birefringent optical unit; an image sensor constituted by a first pixel group that receives an extraordinary ray transmitted through the extraordinary ray selection element, and a second pixel group that receives an ordinary ray transmitted through the ordinary ray selection element; an image generation unit configured to generate an ordinary ray image based on signals acquired from pixels belonging to the first pixel group, and generate an extraordinary ray image based on signals acquired from pixels belonging to the second pixel group; and an image processing unit configured to calculate distance information relating to a subject, using the ordinary ray image and the extraordinary ray image.

The present invention in its another aspect provides a method for controlling an imaging apparatus including an imaging optical system; an image sensor; a birefringent optical unit that is disposed between the imaging optical system and the image sensor, and is configured to separate an incident ray into an ordinary ray and an extraordinary ray; and a ray selection unit that is disposed between the birefringent optical unit and the image sensor, and is constituted by an ordinary ray selection element configured to implement transmitting an ordinary ray and an extraordinary ray selection element configured to implement transmitting an extraordinary ray, the method comprises acquiring, out of the pixels constituting the image sensor, first signals from pixels that receive an extraordinary ray transmitted through the extraordinary ray selection element and acquiring second signals from pixels that receive an ordinary ray transmitted through the ordinary ray selection element; generating an extraordinary ray image from the first signals, and generating an ordinary ray image from the second signals; and calculating distance information relating to a subject, using the ordinary ray image and the extraordinary image.

According to the present invention, an imaging apparatus that can simultaneously capture a plurality of images having different degrees of blur can be provided.

Further features of the present invention will become apparent from the following description of exemplary embodiments with reference to the attached drawings.

### BRIEF DESCRIPTION OF THE DRAWINGS

FIG. 1 is a diagram depicting a configuration and an optical path of an imaging apparatus according to Embodiment 1;

FIG. 2 is an enlarged view of an image sensor according to Embodiment 1;

FIG. 3 is a diagram depicting a configuration and an optical path of an imaging apparatus according to Embodiment 2;

FIG. 4 is a second diagram depicting a configuration and an optical path of the imaging apparatus according to Embodiment 2;

FIG. 5 is a diagram depicting a configuration and an optical path of the imaging apparatus according to Embodiment 1;

FIG. 6 is a diagram depicting an optical path in a birefringent optical unit according to Embodiment 2;

FIG. 7 is a diagram depicting a configuration and an optical path of an imaging apparatus according to Embodiment 3;

FIG. 8 is an enlarged view of an image sensor according to Embodiment 3;

FIG. 9 is an enlarged view of an image sensor according to a modification of Embodiment 3;

FIG. 10A to FIG. 10C are enlarged views of an image sensor according to Embodiment 4; and

FIG. 11 is a diagram depicting a birefringent optical unit.

### DESCRIPTION OF THE EMBODIMENTS

### Embodiment 1

An imaging apparatus according to Embodiment 1 will be described with reference to the drawings. As a rule, same composing elements are denoted with a same reference symbol for which redundant description is omitted.

<System Configuration>

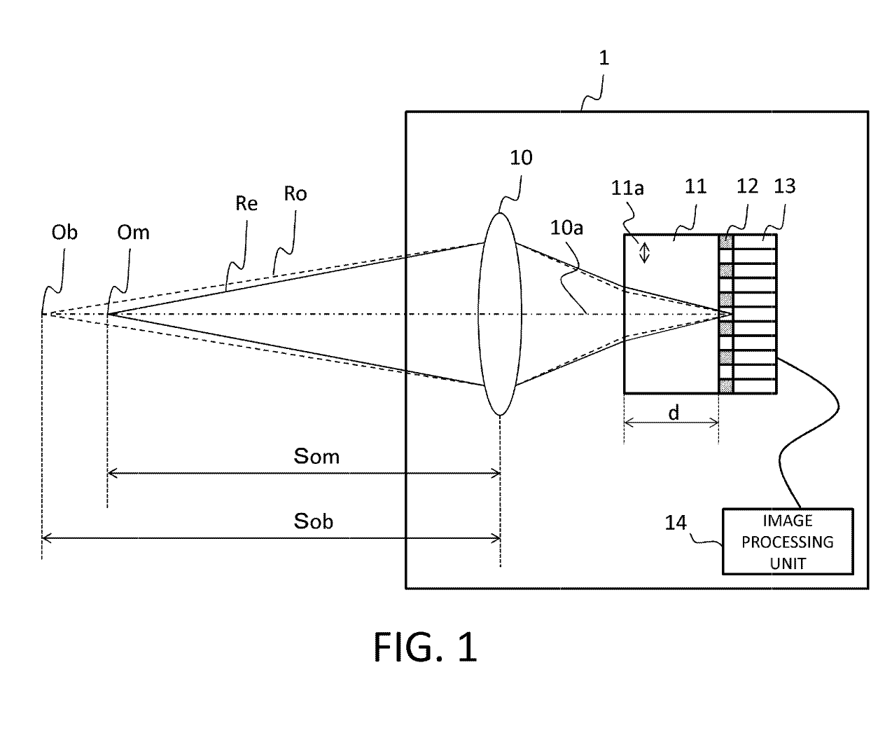

FIG. 1 is a diagram depicting a configuration of an imaging apparatus 1 according to Embodiment 1, and an optical path, when a main subject Om is captured using this imaging apparatus.

The imaging apparatus 1 according to Embodiment 1 includes an imaging optical system 10, a birefringent optical unit 11, a polarizing filter unit 12, an image sensor 13 and an image processing unit 14.

The imaging optical system 10 is an optical system that is constituted by a plurality of lenses, and forms an image of incident rays on an image plane of the image sensor 13.

The birefringent optical unit 11 is a plate type filter constituted by a birefringent substance, and is used for separating incident rays into an ordinary ray and an extraordinary ray. This birefringent optical unit 11 corresponds to the birefringent optical unit according to the present invention.

The polarizing filter unit 12 filters the separated normal ray and the extraordinary ray, and allows either one to pass through. The polarizing filter unit 12 is constituted by a plurality of polarizing plates, and the squares disposed in the vertical direction in FIG. 1 indicate the polarizing plates respectively. A detailed description follows later.

The image sensor 13 has such an image sensor as a CCD or CMOS. The image sensor 13 may be an image sensor that includes a color filter or may be a monochrome image sensor. The image sensor may be a three-plate type. The image sensor 13 is constituted by a plurality of pixels, and the rectangles disposed in the vertical direction in FIG. 1 indicate the pixels respectively.

The image processing unit 14 processes signals outputted from the image sensor 13 and generates an image. In concrete terms, the image processing unit 14 generates two images: an image focused on a main subject, and an image where the main subject is out of focus. Out of the acquired images, the image focused on the main subject is stored as an image for viewing, and is displayed to the user.

The image processing unit 14 also calculates the subject distance by the DFD method using the generated two images. The calculated subject distance is stored in a memory (not illustrated) or is displayed to the user by a display device (not illustrated). A detailed description follows later.

The image processing unit 14 corresponds to the image processing unit according to the present invention.

<Outline of Imaging>

An outline of imaging performed by the imaging apparatus 1 will be described next.

The imaging apparatus 1 according to this embodiment has the birefringent optical unit 11 between the imaging optical system and the image sensor. The birefringent optical unit 11 is a filter constituted by a birefringent substance, hence the incident ray is separated into an ordinary ray and an extraordinary ray, and are emitted. The ordinary ray and the extraordinary ray have mutually different polarizing directions with respect to the optical axis of the birefringent optical unit. In concrete terms, out of the rays that entered the birefringent optical unit 11, components that are on the same plane as the optical axis 11a become extraordinary rays, and components on the plane perpendicular to the optical axis 11a become ordinary rays. The optical axis 11a is an axis unique to birefringent materials, and in Embodiment 1 the direction thereof is parallel with the page surface, and is perpendicular to the optical axis 10a of the imaging optical system.

The refractive index of a ray that passes through the birefringent optical unit 11 is different depending on whether the ray is an ordinary ray or an extraordinary ray. In concrete terms, the optical path length of the extraordinary ray is longer than that of the ordinary ray, since the extraordinary ray has a higher refractive index than the ordinary ray. In other words, rays focused on subjects at different locations respectively reach the image plane of the image sensor 13.

FIG. 1 shows the optical paths of the ordinary ray Ro and the extraordinary ray Re when the focus position of the imaging optical system 10 is fixed. The extraordinary ray Re that comes from a main subject Om forms an image on the image sensor 13 via the birefringent optical unit 11 and the polarizing filter unit 12. In the same way, the ordinary ray Ro that comes from a background subject Ob also forms an image on the image sensor 13 via the birefringent optical unit 11 and the polarizing filter unit 12.

The main subject Om is in a position at the subject distance Som, and the background subject Ob is in a position at the subject distance Sob. The main subject Om and the background subject Ob are located at different distances, but the imaging apparatus 1 can focus on both the subjects Om and Ob since the optical path lengths of the ordinary ray Ro and the extraordinary ray Re are different.

However in this state, the images of the two subjects overlap on the same pixels, which means that images with different focus positions cannot be acquired independently. Therefore the imaging apparatus according to this embodiment separates an incident ray into an ordinary ray and an extraordinary ray using the polarizing filter.

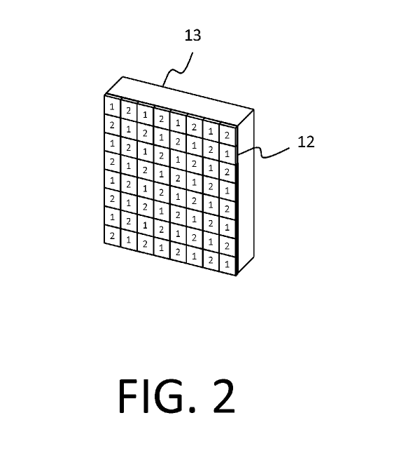

FIG. 2 is an enlarged view of the polarizing filter unit 12 and the image sensor 13. The light that transmitted through the birefringent optical unit 11 enters the image sensor 13 via the polarizing filter unit 12. In the polarizing filter unit 12, a plurality of polarizing plates, which corresponds to the pixels of the image sensor 13 respectively, is disposed, and the ordinary rays and the extraordinary rays are selected respectively by a polarizing plates. In other words, only the ordinary rays enter the pixels where the polarizing plates that allow transmitting the ordinary rays are disposed, and only the extraordinary rays enter the pixels where the polarizing plates that allow transmitting extraordinary rays are disposed.

Numbers (1 and 2) shown in FIG. 2 indicate a type of polarizing plate. In concrete terms, a polarizing plate indicated by 1 is a polarizing plate that allows transmitting a ray of which polarizing direction is on the same plane as the optical axis of the birefringent optical unit 11 (extraordinary ray), and a polarizing plate indicated by 2 is a polarizing plate that allows transmitting a ray of which polarizing direction is on the plane perpendicular to the optical axis of the birefringent optical unit 11 (ordinary ray). In this way, the polarizing filter unit 12 is constituted by polarizing plates having different characteristics, which are displayed in a lattice pattern.

The polarizing filter unit 12 corresponds to the light selection unit according to the present invention. The polarizing plate that allows transmitting the extraordinary rays corresponds to the extraordinary ray selection element according to the present invention, and the polarizing plate that allows transmitting the ordinary rays corresponds to the ordinary ray selection element according to the present invention. In the description on embodiments, these polarizing plates are called “first polarizing filter” and “second polarizing filter” respectively.

A plurality of pixels that receives the extraordinary rays corresponds to the first pixel group according to the present invention, and a plurality of pixels that receives the ordinary rays corresponds to the second pixel group according to the present invention. In the description on embodiments, these pixel groups are called “first pixels” and “second pixels” respectively.

As described above, in the imaging apparatus according to Embodiment 1, the first pixels where only the extraordinary ray Re enters and the second pixels where only the ordinary ray Ro enters are separated from each other. Therefore an image focused on the main subject Om can be acquired if an image is constructed using only the signals outputted from the first pixels, and an image focused on the background subject Ob can be acquired if an image is constructed using only the signals outputted from the second pixels. In other words, two images, of which focus positions are different, can be captured simultaneously.

The image processing unit 14 calculates the distance of the subject by the DFD method using the changes of the blur of these two images.

The image constructed using only the first pixels is the extraordinary ray image according to the present invention, and the image constructed using only the second pixels is the ordinary ray image.

<Optical Path Difference and Material of Birefringent Optical Unit>

The optical path difference of the ordinary ray and the extraordinary ray, and the materials used for the birefringent optical unit will be described next.

Here if the focal length f of the imaging optical system 10 in the imaging apparatus 1 is 18 mm, the aperture value F is 4.0, and the subject distance Som of the main subject Om is 3.0 m, then the image distance Sim (not illustrated) becomes 18.109 mm.

If the subject distance Sob of the background subject Ob is 4.0 m, the image distance Sib (not illustrated) becomes 18.081 mm, which means that the difference ΔSi of the image distances of the two focus positions Som and Sob is −0.028 mm. In other words, the optical path difference ΔL between the ordinary ray and the extraordinary ray that must be ensured is 0.028 mm.

The materials that can be used for the birefringent optical unit are quartz, calcite, liquid crystal, photonic crystal, an anisotropic nano-structural optical element or the like, but quarts is used in this embodiment. To acquire a 0.028 mm optical path difference, the thickness d of the quartz is set to 3.077 mm, since the refractive index of the ordinary ray (hereafter called “ordinary ray refractive index No”) of quartz is 1.5443, and the refractive index of the extraordinary ray (hereafter called “extraordinary ray refractive index Ne”) of quartz is 1.5534. The method for calculating the optical path difference will be described later.

The birefringent amount of the quartz (ΔN=Ne−No) is 0.0091, which is relatively small among the above mentioned birefringent optical materials, but a 0.028 mm focus bracket amount can be ensured using about a 3 mm thickness, which is a practical value.

In the imaging apparatus according to this embodiment, the direction of the optical axis 11a of the birefringent optical unit is set to be perpendicular to the optical axis 10a of the imaging optical system. As this direction becomes closer to the direction that is perpendicular to the optical axis of the imaging optical system, the difference of refractive indexes between the ordinary ray and the extraordinary ray increases. In other words, the thickness of the birefringent optical unit 11 required for acquiring the necessary optical path difference can be decreased. The angle β formed by the optical axis 11a of the birefringent optical unit and the optical axis 10a of the imaging optical system is preferable in a range that satisfies Expression 1.

[Math. 1]

70 (deg)≦β≦110 (deg) Expression (1)

If the angle β is 70° or more 110° or less, the optical path difference between the extraordinary ray Re and the ordinary ray Ro can be ensured without increasing the thickness of the birefringent optical unit, and the imaging apparatus can be smaller and lighter.

In this embodiment, the optical path difference ΔL between the extraordinary ray and the ordinary ray is 0.028 mm, but a required optical path difference can be appropriately changed according to the capturing conditions of the imaging optical system.

<Method for Calculating Optical Path Difference>

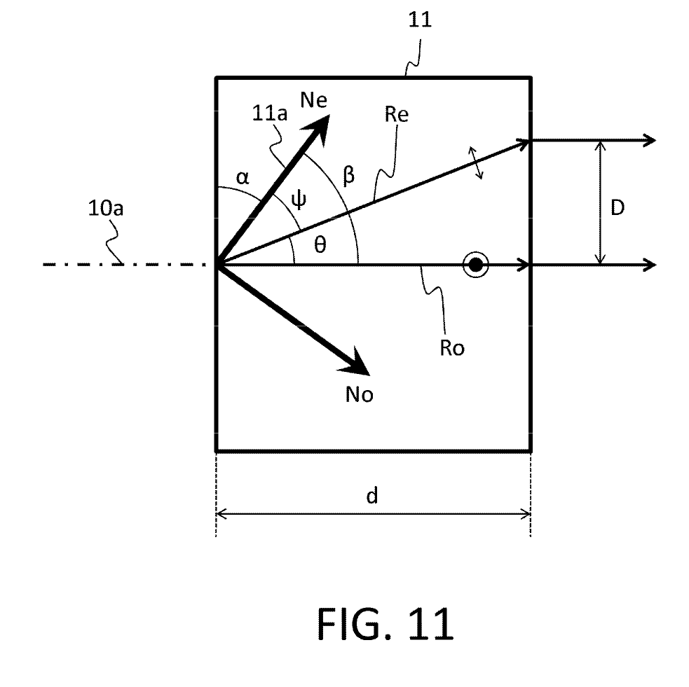

Now a method for calculating the optical path difference between the ordinary ray Ro and the extraordinary ray Re will be described with reference to FIG. 11, which is a diagram of optical paths of the ordinary ray Ro and the extraordinary ray Re that pass through the birefringent optical material.

The birefringent optical materials, such as quartz, calcite and liquid crystal have anisotropic refractive indices, and in the case of uniaxial crystal, the birefringent material has two refractive indices: an ordinary ray refractive index No and an extraordinary ray refractive index Ne.

The refractive index of a ray of which polarizing direction is perpendicular to the optical axis 11a (that is, S-polarized ordinary ray Ro) is always No. On the other hand, the refractive index of a ray of which polarizing direction is parallel with the optical axis 11a (that is, P-polarized extraordinary ray Re) differs depending on the angle. The refractive index of the extraordinary ray reaches the maximum value Ne when the angle formed by the direction of the ray and the optical axis 11a is 90°. If this angle is not 90°, the refractive index is determined by both Ne and No. If φ (deg) is the angle formed by the extraordinary ray Re that travels through the birefringent optical material and the optical axis 11a, then the refractive index Np of the extraordinary ray Re is given by Expression 2.

$$\begin{matrix}[ Math . 2 ] & \\ \frac{1}{{Np}^{2}} = \frac{{cos}^{2} φ}{{No}^{2}} + \frac{{sin}^{2 } φ}{{Ne}^{2}} & Expression ( 2 )\end{matrix}$$

If φ (deg) is an angle formed by the extraordinary ray Re that travels through the birefringent optical material and the optical axis 11a, then φ is given by the following Expression 3.

[Math. 3]

φ=90−θ−α Expression (3)

Here θ (deg) is an angle formed by the ordinary ray Ro and the extraordinary ray Re that travel through the birefringent optical material. α (deg) is an angle formed by the optical axis 11a and the axis perpendicular to the ordinary ray Ro that travels through the birefringent optical material (that is, an angle formed by the optical axis 11a and the axis perpendicular to the optical axis 10a of the imaging optical system).

The angle θ (deg) formed by the ordinary ray Ro and the extraordinary ray Re that travel through the birefringent optical material is given by Expression 4.

[Math. 4]

$$tan θ = \frac{[ {( \frac{Ne}{No} )}^{2} - 1 ] \times tan α}{1 + {( \frac{Ne}{No} )}^{2} \times {tan}^{2} α} \qquad Expression ( 4 )$$

The optical path length Lo of the ordinary ray Ro that passes through the birefringent optical material is given by Expression 5, and the optical length of the extraordinary ray Re is given by Expression 6. The optical path difference ΔL between the extraordinary ray Re and the ordinary ray Ro is given by Expression 7. Here d (mm) denotes the thickness of the birefringent optical material.

$$\begin{matrix}[ Math . 5 ] & \\ Lo = No \times d & Expression ( 5 ) \\ [ Math . 6 ] & \\ Le = \frac{Np \times d}{cos θ} & Expression ( 6 ) \\ [ Math . 7 ] & \\ Δ L = Le - Lo & Expression ( 7 )\end{matrix}$$

In this way, the optical path difference ΔL (mm) between the extraordinary ray Re and the ordinary ray Ro that pass through the birefringent optical material can be determined using Expression 2 to Expression 7. Therefore when the material of the birefringent optical unit is determined (that is, when No and Ne are uniquely determined), a predetermined optical path difference ΔL can be acquired if the values α and d are set appropriately. In Embodiment 1 however, α is a fixed value since the direction of the optical axis 11a is fixed.

<Method for Calculating Subject Distance>

Now a method for calculating an subject distance, which the image processing unit 14 performs after acquiring two images of which focus positions are different, will be described.

When an subject is located at a focus point (hereafter called “focus position”) in the imaging optical system 10, an image of the subject formed on the image sensor 13 has a high sharpness. As the subject becomes further away from the focus position, the sharpness gradually decreases, and the image blurs. This means that the distance from the focus position can be acquired by comparing the changes in the blur.

The image processing unit 14 according to Embodiment 1 extracts the frequency components of a specific frequency band from the two picked-up images, and estimates the subject distance based on the changes in the blur between the extracted images.

In concrete terms, the image processing unit 14 extracts the specific frequency components from the corresponding local areas of the two picked-up images, calculates a correlation value between the two images, and calculates the distance information of the subject based on the correlation value. The correlation value NCC in this local area is given by Expression 8.

$$\begin{matrix}[ Math . 8 ] & \\ NCC = \frac{\sum ( I {1}_{i} - I {1}_{av} ) ( I {2}_{i} - I {2}_{av} )}{\sqrt{\sum {( I {1}_{i} - I {1}_{av} )}^{2}} \sqrt{\sum {( I {2}_{i} - {I2}_{av} )}^{2}}} & Expression ( 8 )\end{matrix}$$

Here I1ᵢ denotes a signal value of a frequency component in the local area of the first image (hereafter called “image 1”), and I1ₐᵥ denotes an average value of the signal values of the frequency components in the local area of image 1. I2ᵢ denotes a signal value of a frequency component in the local area of the second image (hereafter called “image 2”), and I2ₐᵥ denotes an average value of the signal values of the frequency components in the local area of image 2.

In the case of acquiring two images by a focus bracket, the correlation value NCC becomes highest at a mid-point of the focus positions of the two images, and decreases as the subject moves away from this position. Therefore by determining the correlation value, it can be known how far the subject is distant from the mid-point of the focus positions of the two images.

It is also possible to identify whether the subject is located at the front side (imaging apparatus side) or at the rear side of the mid-point of the focus positions of the two images.

In concrete terms, the subject is at the focus position side of the image 1 if Expression 9 is satisfied, and the subject is at the focus position side of image 2 if Expression 10 is satisfied.

[Math. 9]

Σ(I1ᵢ−I1ₐᵥ)²>Σ(I2ᵢ−I2ₐᵥ)² Expression (9)

[Math. 10]

Σ(I1ᵢ−I1ₐᵥ)²<Σ(I2ᵢ−I2ₐᵥ)² Expression (10)

In this example, it is assumed that the focus position of image 1 is at the front side (imaging apparatus side) of the mid-point of the focus positions of the two images, and the focus position of image 2 is at the rear side thereof.

In this way, it can be determined whether the position of the subject is at the front or rear of the mid-point of the focus positions of the two images. By reflecting this determination result in the calculation result using the DFD method, the distance information can be calculated.

For example, when a correlation value DS calculated by Expression 8 is provided, a distance dependent value DSR, in which the front/rear determination is reflected, can be acquired by converting DS using the following conditions. DS, which is a value indicating correlation, is in the 0 to 1 range, but the range can be in the 0 to 2 range with 1 as the mid-point if DS is converted into DSR.

the front/rear determination result is at the “front side”: DSR=2−DS

the front/rear determination result is at the “rear side”: DSR=DS

To convert the distance dependent value into an actual distance, the relationship between the distance and the calculated correlation value is calculated and stored in advance, and an actual value is calculated from the stored correlation value by backward processing.

There are two methods to extract frequency components. One is to perform a convolution operation on the picked-up image using a bandpass filter designed for real space, and extracting only the frequency components in a specific frequency band. If this method is used, image processing can be performed only in a real space, hence the operation cost is low. The other method is Fourier-transforming the picked-up image into an image in a frequency space, extracting only the frequency components in a specific frequency band, and performing inverse Fourier transform to return the frequency space image back to the real space image. If this method is used, only the specific frequency band can be cleanly extracted.

The distance information acquired here is a relative distance from the mid-point of the focus positions of the two images, but the absolute distance from the imaging apparatus to the subject may be determined. For this, the distance S_{obj} from the imaging apparatus to the focus position of the imaging optical system must be determined first using Expression 11. Here S_{img} denotes a distance from the imaging optical system to the image plane, and f denotes a focal length of the imaging optical system.

$$\begin{matrix}[ Math . 11 ] & \\ \frac{1}{{S}_{obj}} = \frac{1}{{S}_{img}} - \frac{1}{f} & Expression ( 11 ) \\ [ Math . 12 ] & \\ {S}_{obj} 3 = \frac{{S}_{obj} 1 + {S}_{obj} 2}{2} & Expression ( 12 )\end{matrix}$$

By Expression 11, the distance S_{obj}1 from the imaging apparatus to the focus position when image 1 was captured, and the distance S_{obj}2 from the imaging apparatus to the focus position when image 2 was captured can be determined. By Expression 12, the distance S_{obj}3 from the imaging apparatus to the mid-point of the focus bracket can be determined.

Thereby the absolute distance from the imaging apparatus to the subject can be determined. If a plurality of subject distances are acquired, a depth map, corresponding to the image, can be generated.

In a general imaging apparatus, a certain time difference is required to capture two images of which focus positions are different, therefore a positional shift is generated by subject movement and camera shaking, and the shift must be corrected after capturing the images.

In the case of the imaging apparatus according to this embodiment however, the two images of which focus positions are different can be simultaneously captured, hence the processing to correct the positional shift can be omitted. In other words, the calculation cost can be reduced and the processing time can be shortened. Further, the distance measurement accuracy in the DFD method can be improved.

In this embodiment, quartz is used for the birefringent optical unit, however other materials, such as calcite, may be used instead. In the case of using calcite, the refractive index No of an ordinary ray is 1.4864, the refractive index Ne of an extraordinary ray is 1.6584, and the birefringent amount ΔN is 0.1729, which are much larger values than in the case of quartz. Therefore a 0.028 mm optical path difference can be obtained if the thickness d of the birefringent optical unit 11 is 0.163 mm.

Liquid crystal may be used for the birefringent optical unit instead. In the case of liquid crystal, the refractive index No of an ordinary ray is 1.50, the refractive index Ne of an extraordinary ray is 1.70, and the birefringent amount ΔN is 0.20, which are even larger values than in the case of calcite. Therefore a 0.028 mm optical path difference can be obtained if the thickness d of the birefringent optical unit 11 is set to 0.140 mm.

If such an optical materials having a large refractive index is used, the thickness of the birefringent optical unit 11 can be decreased.

The image processing unit 14 may perform the image processing using the acquired subject distance. For example, a process that adds blur, by which degree of blur increases according to the distance from the main subject, may be performed on an image captured by focusing on the main subject. If the distance to the subject included in the image can be accurately determined, an image with a beautiful blur effect can be generated.

In this embodiment, it was mentioned that the absolute distance from the imaging optical system to the subject can be determined, but the absolute distance need not always be calculated. For example, such processing as subject extraction, background blurring and adding blur effect can be performed using only the relative distance from the focus position.

### Embodiment 2

In Embodiment 1, rays having a same angle of view which come from different focus positions in the imaging optical system are guided to a same pixel on the image sensor. In Embodiment 2 however, rays having a same angle of view which come from different focus positions in the imaging optical system are guided to different pixels, depending on whether the ray is an ordinary ray or an extraordinary ray.

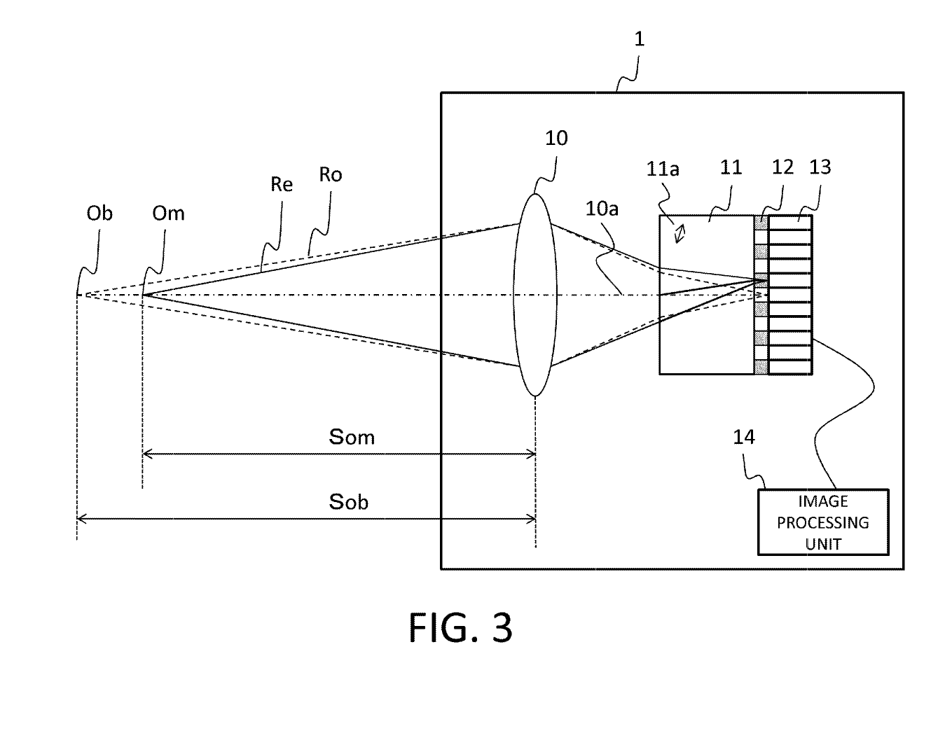

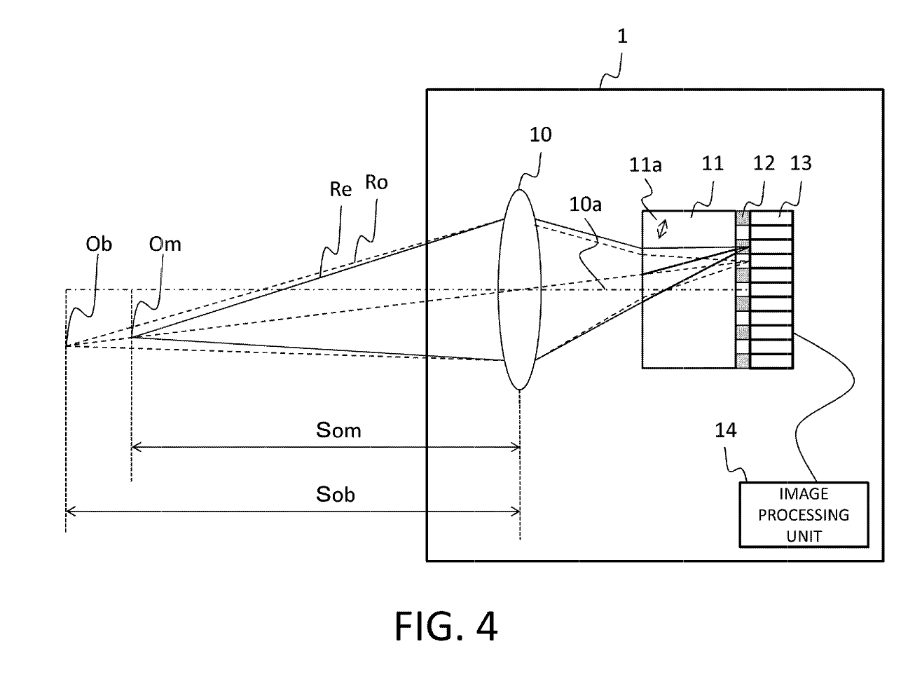

FIG. 3 is a diagram depicting a configuration of an imaging apparatus according to Embodiment 2, and the optical paths when the main subject Om and background subject Ob are imaged using the imaging apparatus. FIG. 4 is a diagram depicting the optical paths when a main subject Om and a background subject Ob, located at different angles of view, are imaged.

The imaging apparatus 1 according to Embodiment 2 simultaneously captures two images having different focus positions by separating an ordinary ray and an extraordinary ray, and allowing each ray to form an image on the image sensor 13, just like Embodiment 1, but the direction of the optical axis of the birefringent optical unit 11 is different from Embodiment 1.

In concrete terms, the direction of the optical axis 11a is inclined from the direction perpendicular to the optical axis 10a of the imaging optical system 10. Thereby rays having a same angle of view which came from different focus points Om and Ob in the imaging optical system 10 can be guided to different pixels.

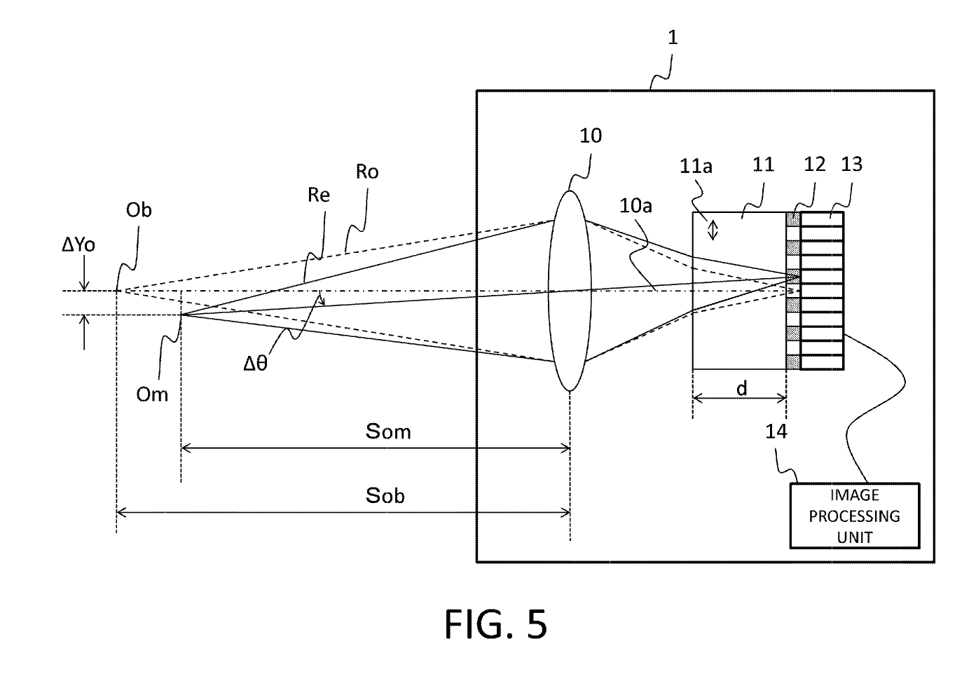

The effect of inclining the optical axis will be described with reference to FIG. 5, which is a diagram depicting the configuration of the imaging apparatus according to Embodiment 1.

As described above, the imaging apparatus 1 according to Embodiment 1 can simultaneously capture two images having different focus positions, by forming images of an ordinary ray Ro and an extraordinary ray Re on the image sensor 13 respectively.

However the pixel where the ordinary ray enters and the pixel where the extraordinary ray enters are shifted from each other by one pixel, hence if two images are acquired, the angle of view is slightly different between these images. In concrete terms, the image when the main subject Om of which focus position is Som is captured and the image when the background subject Ob of which focus position is Sob is captured are acquired, therefore the angles of view are shifted from each other by one pixel (Δθ). The object height is shifted by ΔYo on the object plane as well.

It is certain that when the distance of the subject is calculated by the DFD method, the distance of the subject can be calculated in most of the image without problem if the shift in the angle of view is only about 1 pixel. However in the boundary portion of the subject, the measurement accuracy of the subject distance may drop due to the one pixel shift.

Therefore in the imaging apparatus according to Embodiment 2, this one pixel shift is solved by shifting the image forming positions of the ordinary ray and the extraordinary ray on the image sensor respectively.

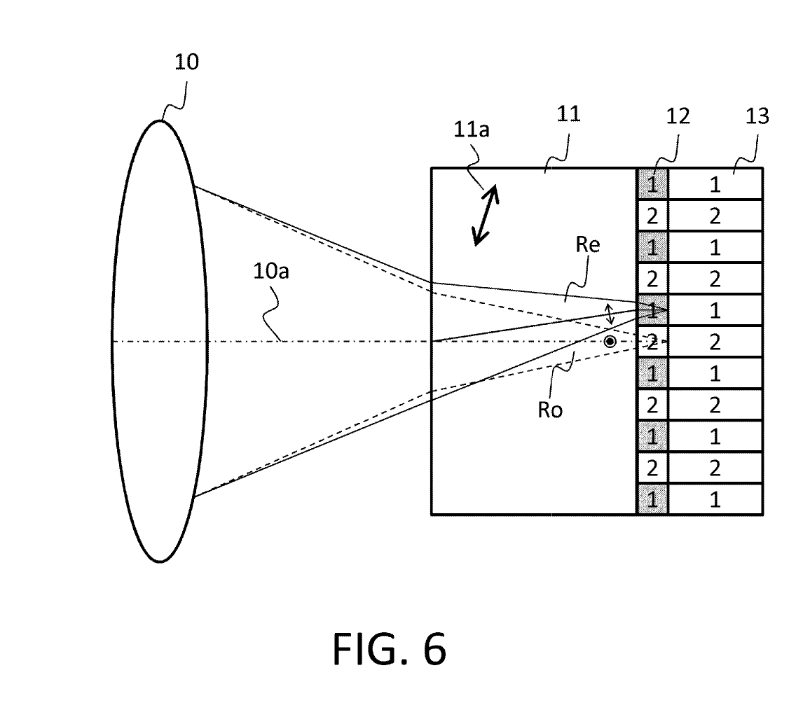

FIG. 6 is a diagram of optical paths from the imaging optical system to the image sensor, showing a state of the rays (Ro and Re) that come from the two object points Om and Ob shown in FIG. 3 to form images on the image sensor 13.

In Embodiment 2, the direction of the optical axis 11a of the birefringent optical unit 11 is set so as to form an angle that is not 90° from the optical axis 10a of the imaging optical system 10. Thereby the rays having a same angle of view that come from different focus positions can be formed on the image sensor always maintaining a one pixel shift. The rest of the configuration of the polarizing filter unit 12 and the image sensor 13 is the same as Embodiment 1. In other words, in FIG. 6, the first filter (first polarizing filter) and the pixels (first pixels) correspond to the extraordinary ray Re, and the second filter (second polarizing filter) and the pixels (second pixels) correspond to the ordinary ray Ro.

As shown in FIG. 3, the extraordinary ray Re is a ray that come from the main subject Om, hence if an image is constructed using only the first pixels, an image focused on the main subject Om can be acquired. The ordinary ray Ro is a ray that comes from the background subject Ob, hence if the image is constructed using only the second pixels, an image focused on the background subject Ob can be acquired. The positions of the subject in these images perfectly match with each other.

The separation amount between the extraordinary ray Re and the ordinary ray Ro on the image sensor 13 depends on the direction of the optical axis 11a. The distance between pixels (distance from the center of a pixel to the center of an adjacent pixel) of the image sensor 13 of this embodiment is 2 μm, hence the direction of the optical axis 11a is set such that the separation amount between the extraordinary ray Re and the ordinary ray Ro becomes 2 μm.

In concrete terms, quartz is used for the birefringent optical unit 11, and the direction of the optical axis 11a is inclined by 3.15° from the direction perpendicular to the optical axis 10a of the imaging optical system. In other words, the angle formed by the optical axis 11a of the birefringent optical unit and the optical axis 10a of the imaging optical system is 86.85°.

Thereby the extraordinary ray Re and the ordinary ray Ro having a same angle of view enter the adjacent pixels on the image sensor 13 respectively.

<Method for Calculating Separation Amount>

A method for calculating the separation amount between the extraordinary ray Re and the ordinary ray Ro on the image sensor will now be described with reference to FIG. 11. As shown in Expression 3, the extraordinary ray Re travels in a direction that is separate from the ordinary ray Ro by angle θ (deg) from the ordinary ray Ro. In this case, the separation amount D (mm) on the image sensor is given by Expression 13. In other words, the thickness d of the birefringent optical unit 11 and the inclination α of the optical axis 11a are set such that a predetermined optical path difference is obtained, and the separation amount D becomes 2 μm.

[Math. 13]

D=d tan θ Expression (13)

In Embodiment 2 as well as in Embodiment 1, the focus bracket capturing is performed between two images with moving the focus position on the image side by 0.028 mm.

Therefore the birefringent optical unit 11 of this embodiment is constructed such that the optical path length of the extraordinary ray Re becomes 0.028 mm longer than the optical path length of the ordinary ray Ro when the rays pass through. In concrete terms, the thickness d of the birefringent optical unit 11 is set to 3.086 mm. Thereby the optical path length Le of the extraordinary ray Re and the optical path length Lo of the ordinary ray Ro that pass through become 4.794 mm and 4.766 mm respectively, and the optical path difference ΔL=0.028 mm can be ensured.

In this way, the imaging apparatus according to Embodiment 2 can allow the ordinary ray and the extraordinary ray that come from the same angle of view to enter different pixels by changing the direction of the optical axis of the birefringent optical unit 11.

As described in the related art, in the case of calculating the subject distance using the DFD method, the positions of the subject included in the two images are preferably matched. In this embodiment, the positions of the subject of the two images having the same angle of view can be accurately matched in sub-pixel units, therefore focus bracket images appropriate for the distance measurement based on the DFD method can be captured. Further, distance measurement accuracy can be improved throughout the entire image area.

In this embodiment, quart is used for the birefringent optical unit, but other materials may be used, just like Embodiment 1. For example, calcite may be used for the birefringent optical unit. In this case, the direction of the optical axis 11a is inclined by 2.87° from the direction perpendicular to the optical axis 10a of the imaging optical system, so that the angle β formed by the optical axis 11a of the birefringent optical unit and the optical axis 10a of the imaging optical system becomes 87.13°. Additionally, the thickness d of the birefringent optical unit 11 is set to 0.163 mm, then the separation amount D becomes 2 μm and the optical path difference ΔL becomes 0.028 mm.

Liquid crystal may be used for the birefringent optical unit instead. In this case as well, the direction of the optical axis 11a is inclined by 2.87° from the direction perpendicular to the optical axis 10a of the imaging optical system, so that the angle β formed by the optical axis 11a of the birefringent optical unit and the optical axis 10a of the imaging optical system becomes 87.13°. Additionally, the thickness d of the birefringent optical unit 11 is set to 0.141 mm, then the separation amount D becomes 2 μm, and the optical path difference ΔL becomes 0.028 mm.

In this way, the thickness of the birefringent optical unit 11 can be further decreased by using an optical material having a larger refractive index.

In this embodiment, the separation amount between the extraordinary ray Re and the ordinary ray Ro on the image sensor 13 is one pixel, and the first pixel and the second pixel are alternately disposed, but the separation amount may be increased and a plurality of first pixels and a plurality of second pixels may be alternately disposed. However considering that the angle of the ray that enters the birefringent optical unit 11 changes at each angle of view, it is preferable that the separation amount is minimized to keep sensitivity low, so that a predetermined separation amount can be acquired at any angle of view.

The direction to separate the ordinary ray and the extraordinary ray may be a direction that is different from the direction used in this example. This direction can be freely set depending on the direction of the optical axis 11a.

### Embodiment 3

An imaging apparatus according to Embodiment 3 is a color imaging apparatus equipped with an image sensor including a color filter.

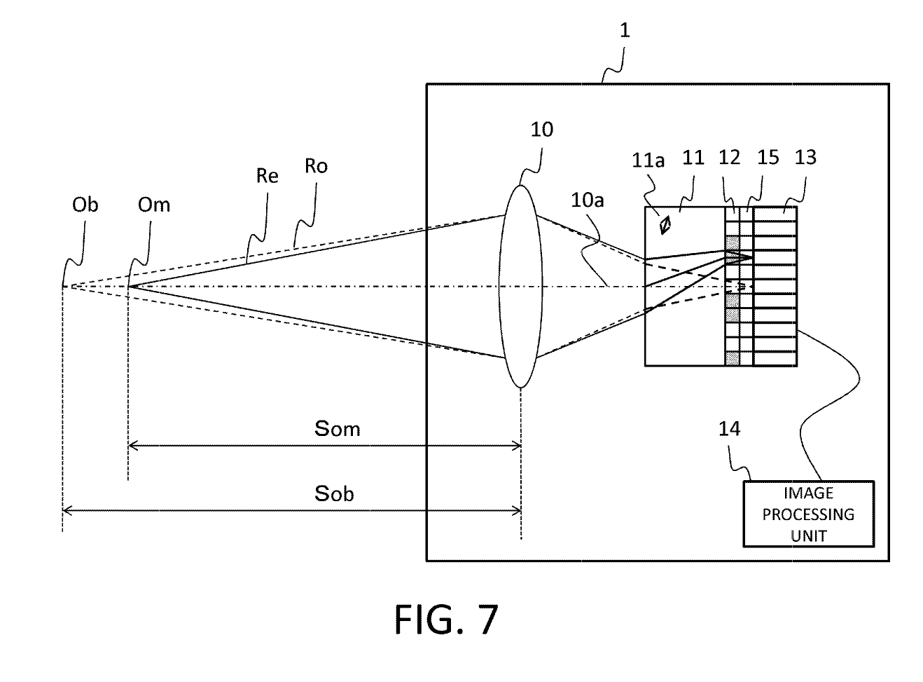

FIG. 7 is a diagram depicting a configuration of the imaging apparatus according to Embodiment 3. A difference of the imaging apparatus of Embodiment 3 from that of Embodiment 2 is that in Embodiment 3 a color filter corresponding to each pixel is disposed between the polarizing filter unit 12 and the image sensor 13.

The configuration other than the aspect to be described below is the same as Embodiment 2.

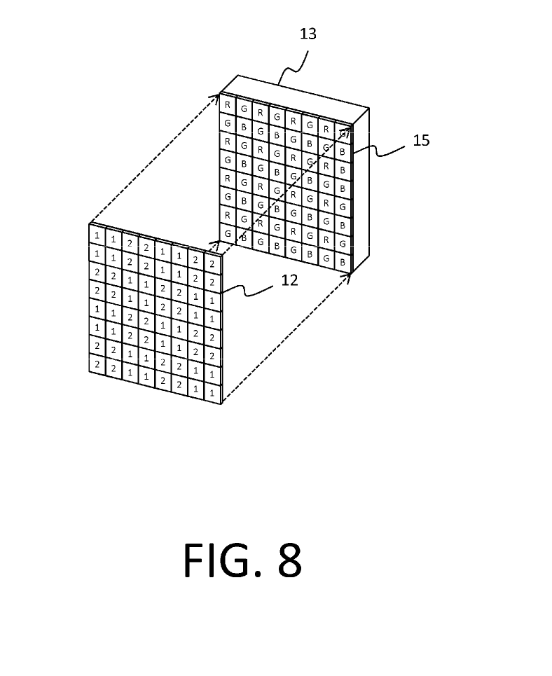

FIG. 8 is a diagram depicting a polarizing filter unit, a color filter and an image sensor of the imaging apparatus according to Embodiment 3.

In the imaging apparatus of this embodiment, as illustrated in FIG. 8, the color filter 15 is disposed between the polarizing filter unit 12 and the image sensor 13. The color filter 15 is constituted by three types of wavelength selection filters corresponding to red, green and blue. The red filter (denoted by R) allows transmitting mainly light in the 580 nm to 720 nm wavelength band, the green filter (denoted by G) allows transmitting mainly light in the 440 nm to 620 nm wavelength band, and the blue filter (denoted by B) allows transmitting mainly light in the 400 nm t 540 nm wavelength band.

In Embodiment 3, the color filter 15 has a R, G and B Bayer array. In other words, filters RGGB corresponding to 2 pixels×2 pixels are regarded as one set, and a plurality of sets of filters is arranged so that the same arrangement pattern is repeated.

Hereafter a set of wavelength selection filters constituted by RGGB is called a “wavelength filter set”, and the corresponding set of four pixels is called a “pixel set”.

As illustrated in FIG. 8, the polarizing filter unit 12 has a configuration where the polarizing direction switches in each wavelength filter set. In other words, the first polarizing filter and the second polarizing filter are alternately disposed in 2 pixel×2 pixel units.

In FIG. 8, the numbers indicated in the polarizing filter unit 12 show the polarizing direction of the ray that the polarizing plate allows to transmit, just like the other embodiments. In other words, the No. 1 filter (first polarizing filter) is the filter that allows transmitting an extraordinary ray, and the No. 2 filter (second polarizing filter) is the filter that allows transmitting an ordinary ray.

In this embodiment, the first polarizing filter and the second polarizing filter are alternately disposed in 2 pixel units, hence the separation amount between the ordinary ray Ro and the extraordinary ray Re must be 2 pixels (4 μm). Therefore according to this embodiment, the direction of the optical axis 11a of the birefringent optical unit 11 is inclined even more than in Embodiment 2, so as to increase the separation amount between the ordinary ray Ro and the extraordinary ray Re.

In concrete terms, quartz is used for the birefringent optical unit 11, and the direction of the optical axis 11a is inclined 6.28° from the direction perpendicular to the optical axis 10a of the imaging optical system. In other words, the angle formed by the optical axis 11a of the birefringent optical unit and the optical axis 10a of the imaging optical system is set to 83.72°.

Further, the thickness d of the birefringent optical unit 11 is set to 3.115 mm. Thereby the optical path length Le of the extraordinary ray Re and the optical path length Lo of the ordinary ray Ro that pass through become 4.838 mm and 4.810 respectively, and the optical path difference ΔL=0.028 mm can be ensured.

According to Embodiment 3, the first polarizing filters and the second polarizing filters are disposed regarding the wavelength filter set, corresponding to each color of RGGB, as one unit, therefore two color images having different focus positions can be simultaneously captured.

In this embodiment, quartz is used as the birefringent optical unit, but other materials may be used, just like Embodiment 1. For example, calcite may be used for the birefringent optical unit. In this case, the direction of the optical axis 11a is inclined by 5.72° from the direction perpendicular to the optical axis 10a of the imaging optical system, so that the angle β formed by the optical axis 11a of the birefringent optical unit and the optical axis 10a of the imaging optical system becomes 84.29°. Additionally, the thickness d of the birefringent optical unit 11 is set to 0.165 mm, then the separation amount D becomes 2 μm, and the optical path difference ΔL becomes 0.028 mm.

Liquid crystal may be used for the birefringent optical unit instead. In this case as well, the direction of the optical axis 11a is inclined by 5.72° from the direction perpendicular to the optical axis 10a of the imaging optical system, so that the angle β formed by the optical axis 11a of the birefringent optical unit and the optical axis 10a of the imaging optical system becomes 84.29°. Additionally, the thickness d of the birefringent optical unit 11 is set to 0.142 mm, then the separation amount D becomes 2 μm, and the optical path difference ΔL becomes 0.028 mm.

In Embodiment 3, three types of wavelength selection filters, red, green and blue, are used, but filters corresponding to other wavelengths may be used. For example, a near infrared filter that allows transmitting mainly a 700 nm to 900 nm wavelength, an infrared filter that allows transmitting mainly a 1.2 μm to 1.5 μm wavelength, an ultraviolet filter that allows transmitting mainly a 300 nm to 400 nm wavelength or the like may be used.

(Modification of Embodiment 3)

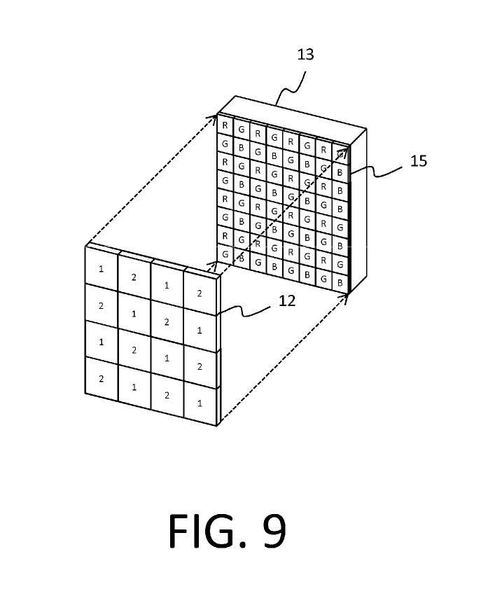

In Embodiment 3, the first polarizing filter or the second polarizing filter is disposed in each pixel, but a polarizing plate having a 2 pixel×2 pixel size may be disposed, as shown in FIG. 9. Then the light quantity loss near the boundary of the polarizing plate can be decreased, and brightness can be ensured. Furthermore, manufacturing becomes easier since a number of polarizing plates can be decreased.

### Embodiment 4

In Embodiment 1 to Embodiment 3, the extraordinary ray image and the ordinary ray image are generated using the first pixels and the second pixels respectively, to measure the subject distance. If this method is used however, only half of all pixels of the image sensor can be used to generate each image respectively, which results in a decrease in resolution of the outputted images.

In Embodiment 4, to handle this problem, distance is measured using only a part of the pixels included in the pixel set in Embodiment 3.

The configuration, other than the aspect described below, is the same as Embodiment 3.

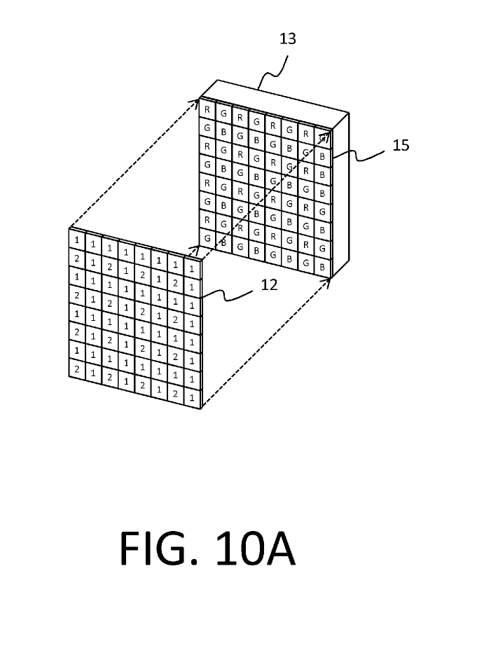

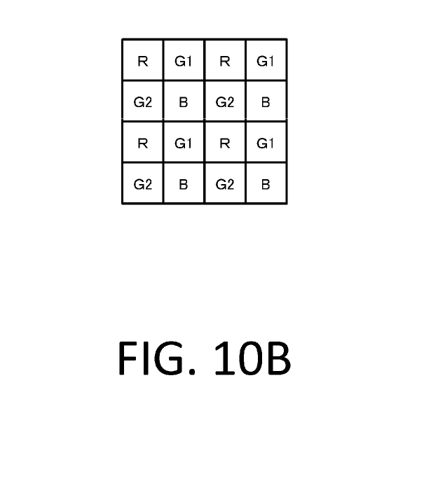

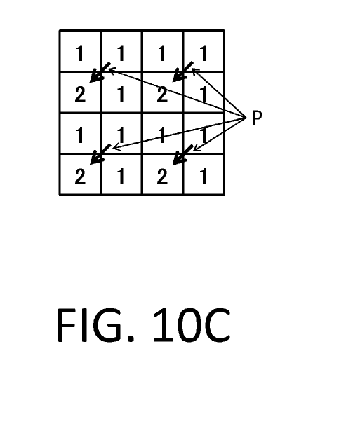

FIG. 10A is a diagram depicting a polarizing filter unit, a color filter and an image sensor of an imaging apparatus according to Embodiment 4. FIG. 10B is an enlarged view of the color filter 15, and FIG. 10C is an enlarged view of the polarizing filter unit 12.

In Embodiment 4 as well as in Embodiment 3, the color filter 15 is disposed in front of the image sensor 13, and the polarizing filter unit 12 is disposed in front of the color filter 15. The color filter 15 has an RGB Bayer array, just like Embodiment 3.

As FIG. 10B shows, each wavelength filter set has two color filters having a same spectral transmittance (that is, green filter G1 and green filter G2).

In Embodiment 4, by utilizing this structure, a plurality of images having different focus positions is acquired using only the pixels corresponding to the green filter G1 and the green filter G2.

In concrete terms, the first polarizing filter is set for each pixel corresponding to the red filter R, green filter G1 and blue filter B, and the second polarizing filter is set for each pixel corresponding to the green filter G2. Then the direction of the optical axis 11a is set such that the image forming position of the ordinary ray and that of the extraordinary ray on the image sensor is shifted in the arrow P direction, as shown in FIG. 10C. Further, the direction of the optical axis 11a and the thickness of the birefringent optical unit 11 are set such that the separation amount between the ordinary ray Ro and the extraordinary ray Re becomes one pixel (1.4 times pixel distance=2.8 μm) in the diagonal direction.

In the imaging apparatus according to Embodiment 4, quartz is used for the birefringent optical unit 11, and the direction of the optical axis 11a is inclined by 4.45° from the direction perpendicular to the optical axis 10a of the imaging optical system. In other words, the angle formed by the optical axis 11a of the birefringent optical unit and the optical axis 10a of the imaging optical system is 85.55°.

Further, the thickness d of the birefringent optical unit 11 is 3.096 mm. Thereby the optical path length Le of the extraordinary ray Re and the optical path length Lo of the ordinary ray Ro that pass through become 4.809 mm and 4.781 mm respectively, and the optical path difference ΔL=0.028 mm can be ensured.

In the imaging apparatus according to Embodiment 4, the image processing unit 14 generates images for distance measurement using only pixels corresponding to the green filters. In concrete terms, the first image for distance measurement is generated using only the pixels corresponding to the green filter G1, and the second image for distance measurement is generated using only the pixels corresponding to the green filters G2. The image for viewing is generated using the pixels corresponding to each R, G1 and B filter.

The two images for distance measurement acquired like this contain only green components, but the positions of the subject in each image match with each other, hence the subject distance can be acquired without any problem by the DFD method.

The image for viewing is generated using all the pixels corresponding to red, green and blue, hence an image for viewing which has higher resolution and better image quality than Embodiment 3 can be generated. Moreover, such image processing as adding blur can be performed with inputting the image for viewing having a high image quality.

In this embodiment, quartz is used for the birefringent optical unit, but other materials may be used, just like Embodiment 1. For example, calcite may be used for the birefringent optical unit. In this case, the direction of the optical axis 11a is inclined by 4.05° from the direction perpendicular to the optical axis 10a of the imaging optical system, so that the angle β formed by the optical axis 11a of the birefringent optical unit and the optical axis 10a of the imaging optical system becomes 85.95°. Additionally the thickness d of the birefringent optical unit 11 is set to 0.164 mm, then the separation amount D becomes 2.8 μm, and the optical path difference ΔL becomes 0.028 mm.

Liquid crystal may be used for the birefringent optical unit instead. In this case as well, the direction of the optical axis 11a is inclined by 4.05° from the direction perpendicular to the optical axis 10a of the imaging optical system, so that the angle β formed by the optical axis 11a of the birefringent optical unit and the optical axis 10a of the imaging optical system becomes 85.95°. Additionally, the thickness d of the birefringent optical unit 11 is set to 0.141 mm, then the separation amount D becomes 2 μm, and the optical path difference ΔL becomes 0.028 mm.

In this embodiment, the distance is measured using only the pixels corresponding to the green filters, but if a plurality of filters corresponding to rays having a same wavelength is included in the wavelength filter set, the distance may be measured using only the pixels corresponding to these filters.

(Modification)

The description on each embodiment is an example used for describing the present invention, and the present invention can be carried out by appropriately changing or combining the embodiments within a scope not departing from the true spirit of the invention. For example, the present invention may be carried out as an imaging apparatus that includes at least a part of the above mentioned processing, or may be carried out as a method for controlling the imaging apparatus. Furthermore, the present invention can also be carried out as a program executed by the imaging apparatus. The present invention may be carried out as an apparatus that not only captures still images, but that also takes moving images. The above processings and units can be freely combined within a scope that does not generate technical inconsistency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-176930, filed on Aug. 28, 2013, which is hereby incorporated by reference herein in its entirety.

What is claimed is:

1. An imaging apparatus, comprising:
an imaging optical system;
a birefringent optical unit configured to separate a ray that passed through the imaging optical system into an ordinary ray and an extraordinary ray;
a light selection unit constituted by an ordinary ray selection element configured to implement transmitting an ordinary ray entering from the birefringent optical unit and an extraordinary ray selection element configured to implement transmitting an extraordinary ray entering from the birefringent optical unit;
an image sensor constituted by a first pixel group that receives an extraordinary ray transmitted through the extraordinary ray selection element, and a second pixel group that receives an ordinary ray transmitted through the ordinary ray selection element;
an image generation unit configured to generate an ordinary ray image based on signals acquired from pixels belonging to the first pixel group, and generate an extraordinary ray image based on signals acquired from pixels belonging to the second pixel group; and
an image processing unit configured to calculate distance information relating to a subject, using the ordinary ray image and the extraordinary ray image.

2. The imaging apparatus according to claim 1, wherein
the birefringent optical unit has an optical axis that intersects with the optical axis of the imaging optical system at an angle other than 90′,
an ordinary ray and an extraordinary ray corresponding to rays, which come from a same angle of view in the imaging optical system, enter two pixels that are separated from each other by a predetermined distance respectively on the image sensor, and
the two pixels belong to different pixel groups respectively.

3. The imaging apparatus according to claim 2, wherein
the predetermined distance is a distance between adjacent pixels in the image sensor.

4. The imaging apparatus according to claim 2, wherein
a pixel set constituted by a plurality of pixels that receive rays having a same wavelength and pixels that receive rays having wavelengths different from this wavelength are disposed in the image sensor in a same repeat pattern, and
in the pixel set, one pixel out of the plurality of pixels that receive rays having a same wavelength and other pixels included in this pixel set belong to different pixel groups.

5. The imaging apparatus according to claim 1, wherein
an angle formed by the optical axis of the birefringent optical unit and the optical axis of the imaging optical system is 70° or more and 110° or less.

6. The imaging apparatus according to claim 1, wherein
the ordinary ray selection element implements transmitting rays, the polarizing direction of which is perpendicular to the optical axis of the birefringent optical unit, and
the extraordinary ray selection element implements transmitting rays, the polarizing direction of which is parallel with the optical axis of the birefringent optical unit.

7. The imaging apparatus according to claim 1, wherein
the ordinary ray image and the extraordinary ray image have different focus positions.

8. A method for controlling an imaging apparatus including:
an imaging optical system;
an image sensor;
a birefringent optical unit that is disposed between the imaging optical system and the image sensor, and is configured to separate an incident ray into an ordinary ray and an extraordinary ray; and
a ray selection unit that is disposed between the birefringent optical unit and the image sensor, and is constituted by an ordinary ray selection element configured to implement transmitting an ordinary ray and an extraordinary ray selection element configured to implement transmitting an extraordinary ray,
the method comprising:
acquiring, out of the pixels constituting the image sensor, first signals from pixels that receive an extraordinary ray transmitted through the extraordinary ray selection element and acquiring second signals from pixels that receive an ordinary ray transmitted through the ordinary ray selection element;
generating an extraordinary ray image from the first signals, and generating an ordinary ray image from the second signals; and
calculating distance information relating to a subject, using the ordinary ray image and the extraordinary image.
